(19) United States
(12) Patent Application Publication
(10) Pub. No.: US 2004/0184228 A1
(43) Pub. Date: Sep. 23, 2004

(54) Electronic apparatus with latch mechanism to fix housings overlaid and connected by hinges

(75) Inventors: Hiroyuki Minaguchi, Higashimatsuyama-shi (JP); Nobuyasu Tajima, Ome-shi (JP); Masanori Sato, Ome-shi (JP); Hidemi Itakura, Nishitama-gun (JP); Takayuki Arisaka, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/765,395

(22) Filed: Jan. 28, 2004

(30) Foreign Application Priority Data
Jan. 29, 2003 (JP) 2003-020389

(51) Int. Cl. G06F 1/16

(52) U.S. Cl. 361/683

(57) ABSTRACT

An electronic apparatus comprises a first housing, a second housing, hinges which connect these two housings, and a latch mechanism which fixes the first housing and second housing in the overlaid state. The latch mechanism comprises a hook member, a lock member, a button, and a push member. When the button is pressed, the lock member rotates around a rotation shaft, and disengages one end from the hook member. As a result, the push member pushes the hook member inserted into a main unit toward the outside of the main unit.

### CROSS-REFERENCE TO RELATED APPLICATIONS

This application is based upon and claims the benefit of priority from the prior Japanese Patent Application No. 2003-020389, filed Jan. 29, 2003, the entire contents of which are incorporated herein by reference.

### BACKGROUND OF THE INVENTION

1. Field of the Invention

The present invention relates to an electronic apparatus with a latch mechanism which fixes a main unit and a display panel overlaid and connected by hinges.

2. Description of the Related Art

An electronic apparatus such as a personal computer (hereinafter referred to as PC) with excellent portability has a main unit and a display panel connected by hinges. Such an electronic apparatus has a latch mechanism to prevent the main unit and display panel from opening while being carried. For example, refer to Jpn. Pat. Appln. KOKAI Publication No. 5-311937, paragraph 0012-0015, FIGS. 1, 5 and 7. The latch mechanism comprises a hook fixed to the display panel, and a lock device (a door open/close device) provided in the main unit to hold the hook.

The lock device is housed in the main unit, and provided with a first cam, a second cam, and a knob which slides the second cam. The first cam has a spring which urges a hook in the direction of pushing it out of the main unit. The second cam has a spring which urges the first cam in the direction of engaging with the hook in the state the first cam is pushed into the main unit by the hook. The knob slides the second cam in the direction of disengaging the second cam from the engagement part.

When the knob is slide and the second cam is disengaged from the hook, the hook is pushed out of the main unit by the first cam. As a result, the display panel rises from the main unit.

However, in the configuration where the knob is slid to disengage the second cam from the engagement part, if the knob is small or knurling on the knob are small, operability is bad. On the other hand, if the knob and knurling on the knob are made large, a part of the knob is projects over the main unit or the surface form becomes different from the surrounding area. As a result, the appearance of PC becomes bad.

### BRIEF SUMMARY OF THE INVENTION

An electronic apparatus according to the present invention comprises a first housing, a second housing, hinges which connect these two housings, and a latch mechanism which fixes the first housing and second housing in the overlaid state. The latch mechanism comprises a hook member, a lock member, a button, and a push member. The hook member is projected from the second housing, and inserted into the first housing in the state the second housing is overlaid on the first housing. The lock member is built in the first housing, and engaged with the hook member in one end, holding the first housing and second housing in being overlaid. The button presses the other end of the lock member. The lock member rotates around a rotation shaft provided between one end and the other end of the lock member. As a result, the button disengages the lock member from the hook member. The push member presses the hook member inserted into the first housing toward the outside of the first housing.

Additional features and advantages of the embodiment will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the preferred embodiments given below, serve to explain the principles of the invention.

FIG. 1 is a perspective view showing a personal computer of one embodiment of the present invention;

FIG. 2 is an exploded perspective view of a latch mechanism of the personal computer of FIG. 1;

FIG. 3 is a sectional view of the personal computer of FIG. 1 showing the state the main unit and display panel are overlaid and the latch mechanism is engaged; and

FIG. 4 is a sectional view of the personal computer of FIG. 1 showing the state a button is pressed in the stat of FIG. 3, a hook member is disengaged from a lock member, and the display panel rises from the main unit.

### DETAILED DESCRIPTION OF THE INVENTION

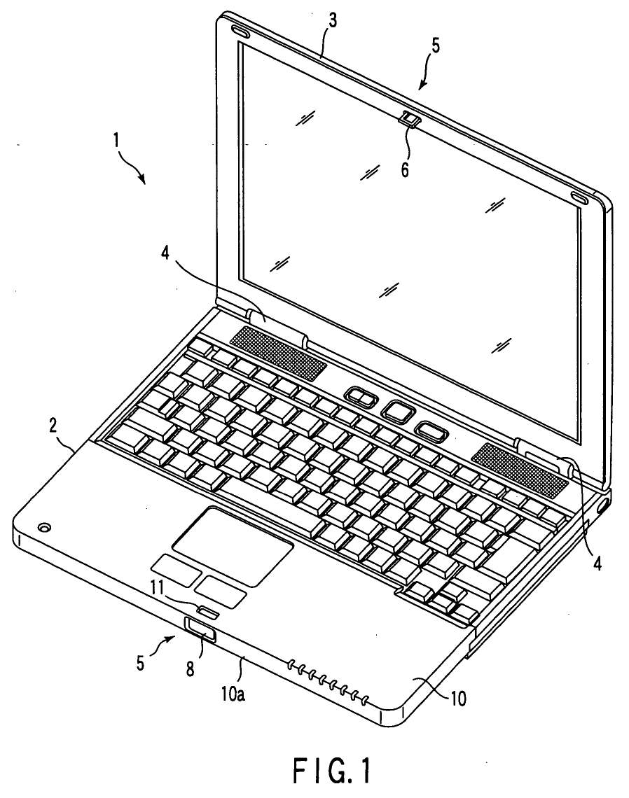

An electronic apparatus of an embodiment of the present invention will be explained hereinafter taking a personal computer 1 (hereinafter referred to as PC) as an example with reference to FIG. 1 to FIG. 4. The PC 1 shown in FIG. 1 comprises a main unit 2 as a first housing, and a display panel 3 as a second housing. The main unit 2 and display panel 3 are connected by hinges 4. The display panel 3 swings between an opened position separated from the main unit 2 and a closed position overlaid on the main unit 2. The PC1 has a latch mechanism 5 in the rotational ends of the main unit 2 and display panel 3, that is, the part opposite to the side provided with the hinge 4. The latch mechanism 5 fixes the main unit 2 and display panel 3 at the closed position.

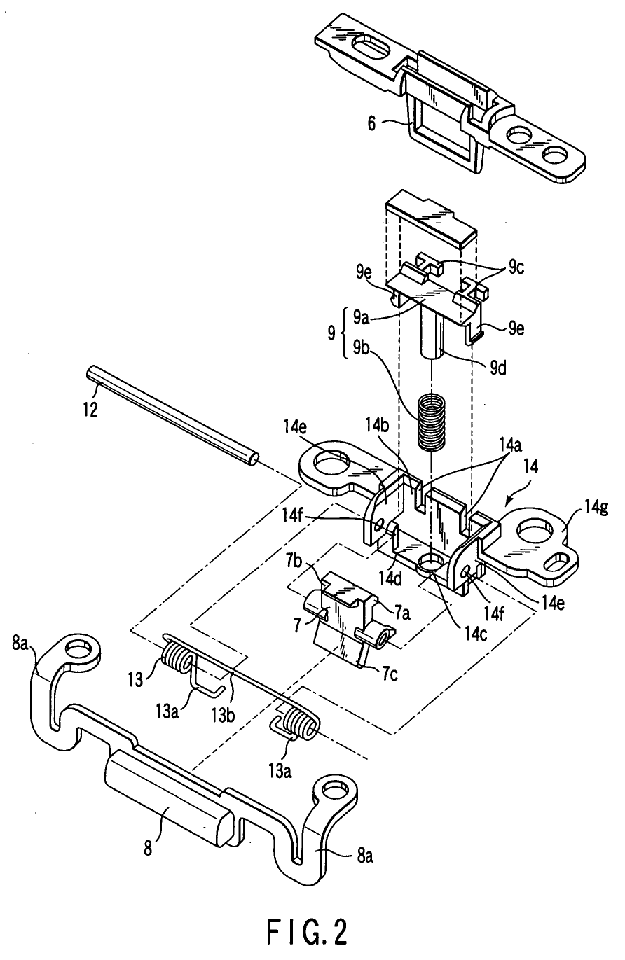

As shown in FIG. 2, the latch mechanism 5 has a hook member 6, a lock member 7, a button 8 and a push member 9. The hook member 6 is provided in the display panel 3, projecting therefrom. When the display panel 3 is overlaid on the main unit 2, the hook member 6 is inserted from the top surface of the main unit 2, concretely inserted into an opening 11. The opening 11 is provided at a position close to a user in a front cover 10 which is used also as a palm rest. The lock member 7 is built in the main unit 2, and provided with a claw 7a at one end 7b. The claw 7a engages with the hook member 6 inserted into the opening 11. In the lock member 7, a rotation shaft 12 is inserted between one end 7b and the other end 7c. The lock member 7 moves rotationally around the rotation shaft 12 between an engage position and a release position. The engage position is the position where the lock member 7 engages with the hook member 6. The release position is the position where the lock member 7 is disengaged from the hook member 6.

The button 8 is arranged to contact with the other end 7c of the lock member 7. The button 8 is exposed to the outside surface of the main unit 2 not covered by the display panel 3, the front edge 10a faced to a user in this embodiment. The button 8 has a support arm 8a in both sides. The support arms 8a are fixed to the rear of the front cover 10.

The latch mechanism 5 has a torsion coil spring 13. The torsion coil spring 13 urges the other end 7c of the lock member 7, rotating around the rotation shaft 12 toward the button 8, toward the engage position. The torsion coil spring 13 shown in this embodiment is a double-torsion type, but use of a single-torsion type is permitted. When a single-torsion type coil spring is used, it can be provided one in one side or one each, total two, in both sides.

The push member 9 comprises a top plate 9a and a coil spring 9b. The top plate 9a knocks against the hook member 6 inserted into the main unit 2. The coil spring 9b is placed behind the top plate 9a opposite to the hook member 6, and urges the top plate 9a toward the outside of the main unit 2. Therefore, the push member 9 receives the hook member 6 inserted into the opening 11 of the main unit 2 by the top plate 9a, and pushes the hook member 6 back toward the outside of the main unit 2, by the coil spring 9b.

The push member 9 and lock member 7 are contained as one unit in the same housing 14. The housing has a wall 14b with slots 14a, a bottom 14d with a hole 14c, and two side walls 14e. The slots 14a guides with projections 9c extended from the top plate 9a of the push member. The hole 14c is inserted a spring guide 9d extended from the underside of the top plate 9a. The bottom plate 14d supports the coil spring 9b. On the two side walls 14e, stoppers 9e extended from both ends of the top plate 9a are hung. The wall 14b, bottom 14d and side walls 14e are arranged orthogonal to one another. The side walls 14e have holes 14f to insert the rotation shaft 12. Both ends 13a of the torsion coil spring 13 are hung on the side walls 14e, and the center portion 13b is hung on one end 7b of the lock member 7. The housing 14 has a holder 14g to be fix to the inside of the main unit 2.

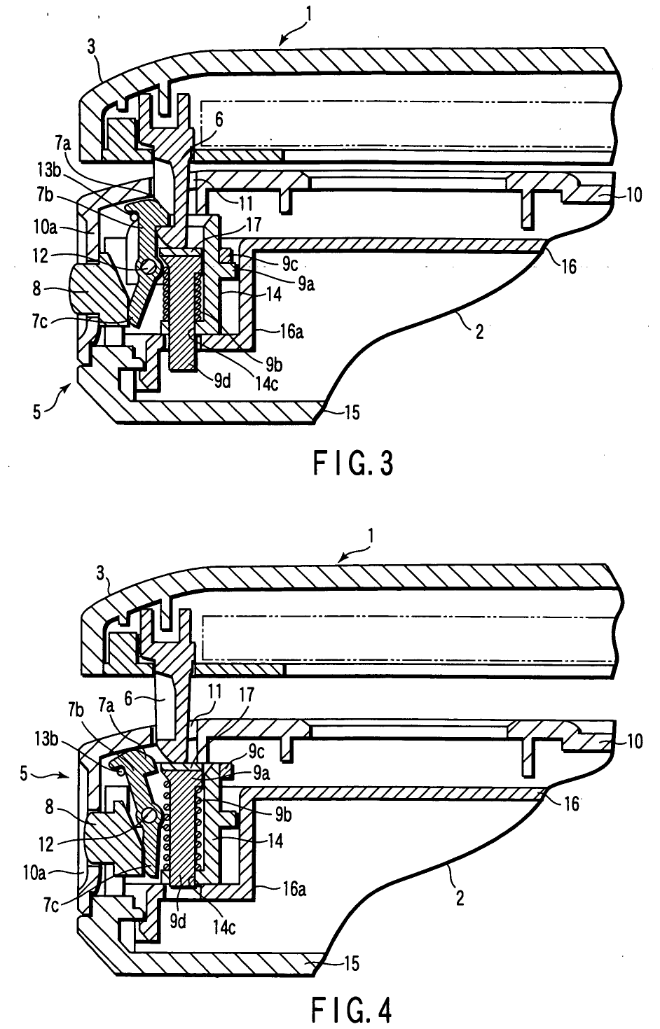

In the main unit 2, an inner frame 16 is provided between a front cover 10 and a base cover 15, as shown in FIG. 3. The housing 14 is fastened to a latch fixing part 16a provided in a part of the inner frame 16. A spacer 17 is provided between the hook member 6 and top plate 9a. The spacer 17 is provided to adjust variations in the distance from the front cover 10 to the top plate 9a caused by the manufacturing error of the front cover 10, base cover 15 and inner frame 16, and the assembling errors in the front cover 10 and base cover 15, and in the base cover 15 and inner frame 16.

In the PC1 configured as described above, when the display panel 3 is put in the closed position overlaying the main unit 2 as shown in FIG. 3, the hook member 6 is inserted into the opening 11 of the main unit 2 and, engaging with the lock member 7. As a result, the display panel 3 is fixed to the main unit 2 in being overlaid thereon.

When raising the display panel 3 by rotating around the hinge 4, push the button 8 exposed to the front surface 10a of the front cover 10. Then, the other end 7c of the lock member 7 is pressed by the button 8, and rotated around the rotation shaft 12 up to the release position. As a result, the claw 7a is disengaged from the hook member 6. When the hook member 6 is disengaged from the lock member 7, the push member 9 pushes the hook member 6 toward the outside of the main unit 2. Then, the display panel 3 is separated from the main unit 2, and raised. Even if the button 8 is released, the display panel 3 is supported by the push member 9 while being raised.

As described above, in the PC1, the display panel 3 is raised by pressing the button 8 in the front surface 10a of the main unit 2. Therefore, a user can raise the display panel 3 simply by inserting a finger into the clearance made between the main unit 2 and display panel 3. As the button 8 is depressed just like being pressed into the main unit 2, the button 8 does not disturb the operation even if the surface is finished smooth to match the surrounding area where the button is exposed. This makes it possible to make the PC good-looking.

The lock member 7 is urged by the torsion coil spring 13 in the direction of pushing the button 8 out of the main unit 2 by the other end 7c. Namely, one end 7b of the lock member 7 is urged toward the hook member 6 inserted into the main unit 2. Therefore, by pushing the display panel 3 toward the main unit 2 reverse against to the force of the coil spring 9b of the push member 9, the hook member 6 and lock member 7 are automatically engaged.

It is permitted to provide the button 8 as one unit with the other end 7c of the lock member 7 by extending the other end 7c. As far as the hook member and lock member can be disengaged by pressing the button, it is also permitted to change the shapes and mechanism of the hook member 6 and lock member 7 shown in this embodiment. Further, the embodiment has been described taking the PC1 as an example of electronic apparatus, but it is also permitted to replace the PC1 by PDA (Personal Digital Assistant), electronic notebook, electronic dictionary and other portable electronic apparatus comprising two housings connected with hinges.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a first housing, a second housing, hinges which connect the two housings, and a latch mechanism which fixes the first housing and second housing in the overlaid state;
wherein the latch mechanism comprises a hook member which is projected from the second housing, and inserted into the first housing in the state the second housing is overlaid on the first housing;
a lock member which is built in the first housing, and engaged with the hook member in one end, holding the first housing and second housing in the overlaid state;
a button which presses the other end of the lock member, rotates the lock member around a rotation shaft provided between said one end and the other end, and disengages the lock member from the hook member; and
a push member which pushes the hook member inserted into the first housing toward the outside of the first housing.

2. The electronic apparatus according to claim 1, wherein the latch mechanism comprises a torsion coil spring which urges the other end of the lock member to rotate around the rotation shaft toward the button.

3. The electronic apparatus according to claim 1, wherein the button is exposed to the outside surface of the first housing not covered by the second housing.

4. The electronic apparatus according to claim 1, wherein the push member comprises a top plate which knocks against the hook member, and a coil spring which urges the top plate toward the outside of the first housing.

5. An electronic apparatus comprising:
a main unit which has an opening;
a display panel which is connected to the main unit, rotatable between an opened position and a closed position to the main unit;
a hook member which is provided in the display panel, and inserted into the opening when the display panel is at the closed position;
a lock member which has a rotation shaft, and is rotatable around the rotation shaft between an engage position where one end is engaged with the hook member inserted into the opening, and a release position where the engagement with the hook member is released;
a button which is provided in the main unit, and rotates the lock member from the engage position to the release position, by pressing the other end of the hook member; and
a push member which is provided in the main unit, and presses the hook member from the closed position to the opened position of the display panel, interlocking with the depression of the button.

6. The electronic apparatus according to claim 5, further comprising a spring which is attached to the lock member, and urges one end of the lock member toward the engage position at all times.

7. The electronic apparatus according to claim 5, further comprising a spring which is attached to the push member, and urges the push member toward the opening at all times.

8. The electronic apparatus according to claim 7, wherein the button is provided and exposed in the front edge of the main unit.

9. The electronic apparatus according to claim 8, further comprising a spacer which is provided at one end of the push member to press the hook member, and arranged between the hook member and one end of the push member when the display panel is at the closed position.
